(19) United States
(12) Patent Application Publication
(10) Pub. No.: US 2011/0086323 A1
(43) Pub. Date: Apr. 14, 2011

(54) Self-Ligating Bracket for Orthodontics

(75) Inventor: Michael WESSINGER, Kampfelbach (DE)

(73) Assignee: Bernhard Forster GmbH, Pforzheim (DE)

(21) Appl. No.: 12/901,212

(22) Filed: Oct. 8, 2010

(30) Foreign Application Priority Data
Oct. 9, 2009 (DE) 10 2009 049 659.9

(51) Int. Cl. A61C 7/14

(52) U.S. Cl. 433/11

(57) ABSTRACT

The bracket comprising
a bracket body having a base,
an occlusal wall extending away from the base and having at least one occlusal ligature wing,
a gingival wall extending away from the base and having at least one gingival ligature wing,
a channel which extends between the occlusal wall and the gingival wall continuously in the direction from mesial to distal,
a sliding element, which is held in a guide of the bracket and can be displaced in the guide, back and forth in the gingival-occlusal direction, between a closed position, in which the channel is closed along at least a portion of its length, and an open position, in which the channel is open in the labial direction,
and means that can hold the sliding element in the closed position thereof and, in the open position thereof, captively secure the sliding element, the means being integrated in the bracket.

### BACKGROUND OF THE INVENTION

1. Field of the Invention

The invention is directed to a self-ligating bracket having the features indicated in the preamble of claim 1. A bracket of this type is known from DE 10 2006 053 215 A1. It includes a one-pieced bracket body on which a rigid sliding element is disposed in a guide. The sliding element can be displaced back and forth between a closed position, in which it bridges a channel of the bracket, and an open position, in which the channel is open in the labial direction. The sliding element is locked both in the closed position thereof and in the open position thereof using a leaf spring disposed in a slot of the bracket body, which is parallel to the channel, and extends into a recess in the underside of the sliding element.

A bracket of this type is characterized as being self-ligating, because the structure used to secure an archwire in a channel in which it has been placed is an integral component of the bracket, the means being the sliding element. This distinguishes self-ligating brackets from brackets in which the archwire must be bonded or secured in a channel—which is open in the labial direction and is also referred to as a slot—of the bracket e.g. using an additional wire ligature or a rubber ring.

2. Description of the Related Art

Brackets, such as the bracket made known in DE 10 2006 053 215 A1, which are equipped with a sliding element that bridges the slot, can be made of metal, plastic, or ceramic. Brackets made of plastic or ceramic have the advantage that they can be designed to be the color of the teeth or translucent, thereby allowing the color of the teeth to show through. Plastic brackets can likewise be transparent. Brackets made of plastic or ceramic have the advantage that they are less conspicuous than brackets made of stainless steel, and are therefore perceived to be less unpleasant. The tiny dimensions of the brackets make it difficult to remain within the narrow dimensional tolerances for the bracket body and the sliding element that are required in order for the bracket body, sliding element, and leaf spring to interact properly, in particular to hold the sliding element securely in the closed position or open position thereof. Moreover, when a translucent or transparent material is used for the bracket and its sliding element, the leaf spring interferes with the aesthetic appearance, because it shows through the bracket.

U.S. Pat. No. 7,025,591 B1 discloses a self-ligating bracket, in the case of which the two lateral walls of the slot are L-shaped and can be swivelled outwardly about an axis that is parallel to the longitudinal direction of the slot. These walls close the slot using the short legs of the L-shaped walls, and close them by swivelling the lateral walls of the slot to the side. A bracket of this type is extremely difficult to manufacture. It must be made of metal and can accidentally come open via the action of the archwire lying in the slot when the archwire presses on one L-shaped wall or the other L-shaped wall.

DE 40 11 988 A1 shows a bracket, in the case of which the distance between two ligature wings can be changed. It is not a self-ligating bracket, however; instead, the two ligature wings are connected by a rubber ring, thereby securing the archwire in the slot.

### BRIEF SUMMARY OF THE INVENTION

The object of the present invention is to create a self-ligating bracket that can be made not only of steel, but also of plastic or ceramic, is robust despite the tininess of the dimensions, and can be reliably closed and held open.

This object is solved by a self-ligating bracket having the features of claim 1. Advantageous developments of the invention are the subject matter of the dependent claims.

The bracket according to the invention has
a bracket body having a base,
an occlusal wall extending away from the base and having at least one occlusal ligature wing,
a gingival wall extending away from the base and having at least one gingival ligature wing,
a channel which extends between the occlusal wall and the gingival wall continuously in the direction from mesial to distal,
a sliding element, which is held in a guide of the bracket and can be displaced in the guide, back and forth in the gingival-occlusal direction, between a closed position, in which the channel is closed along at least a portion of its length, and an open position, in which the channel is open in the labial direction,
and structure that can hold the sliding element in the closed position thereof and captively secure the sliding element in the open position thereof, the structure being integrated in the bracket.
The at least one gingival or occlusal ligature wing and the associated gingival or occlusal wall of the channel are components of the sliding element,
the sliding element has one or more lingual extensions which extend parallel to the base of the channel,
the at least one lingual extension is guided in the guide,
the guide includes a slot which extends below the channel in the bracket, parallel to the base of the channel,
at least the gingival wall or the occlusal wall of the channel has, at a distance from the base of the channel, a labial extension which extends in the direction toward the opposite wall of the channel.

The invention completes a retraction from the bracket disclosed in DE 10 2006 053 215 A1 by presenting the sliding element not as an additional element of the bracket body, but rather by providing a split bracket body and displaceably supporting one of the two parts of the bracket body in a guide of the other part of the bracket body. This does not complete the characterization of the invention, however. In addition, the bracket body is divided in a certain manner i.e. such that the entire surface of one of the two lateral walls limiting the channel is part of a contact surface between the two parts of the bracket body. Either the entire gingival wall of the channel or the entire occlusal wall of the channel is a component of the sliding element, preferably the occlusal wall. As a result, the width of the channel increases when the sliding element is moved into its open position. Conversely, the channel constricts when the sliding element is moved into its closed position. In the closed position, the channel attains a target width that it should have for orthodontic treatment, and it is also closed in the labial direction.

To ensure that the sliding element, in the closed position thereof, can retain an archwire in the channel in which it lies, it is provided according to a further feature of the invention that at least the gingival wall of the channel or the occlusal wall of the channel has a labial extension at some distance from the base of the channel, the extension extending in the direction toward the opposite wall of the channel. This extension bridges the channel in the closed position of the sliding element to such an extent that an archwire lying in the channel cannot be moved out of the channel in the labial direction.

The labial extension preferably extends to the opposite wall of the channel, wherein it is particularly preferred for the labial extension to extend along the entire length of the channel. This is favorable for a simple manufacture of the bracket and is favorable for absorbing forces that can be exerted onto the labial extension by the archwire. It is also favorable for the aesthetic appearance of the bracket and inhibits the disruptive deposition of plaque and food residue.

It is also possible, however, to provide a labial extension on both lateral walls of the channel, and to dimension these extensions in a manner such that, in the closed position of the bracket, they at least constrict the labial access to the channel and preferably close it and, to this end, preferably collide or extend past one another in the direction toward the respective opposite bracket wall, against which it preferably impacts in the closed position of the sliding element.

If only a single labial extension is provided, which is disposed either on the gingival wall or the occlusal wall of the channel, then this labial extension can be provided either on the sliding element or on the opposite, stationary lateral wall of the channel in the bracket body. It is preferably provided on the sliding element. This makes it easy to manufacture the bracket using an injection molding procedure: Plastic injection molding if a bracket is made of plastic; metal injection molding (MIM) if a bracket is metallic; ceramic injection molding (CIM) if a bracket is ceramic.

Furthermore, the sliding element has one or more lingual extensions which extend parallel to the base of the slot. They are guided in a guide which extends e.g. as a slot which extends below the channel in the bracket body, parallel to the base of the channel. This has a plurality of advantages:
The at least one lingual extension of the sliding element can extend, in the closed position thereof, transversely through the solid socket of the bracket, thereby ensuring that the guidance length is sufficient.
The bracket socket has sufficient space e.g. to accommodate a base of the sliding element that is sturdy but not too thin. This is suitable for preventing the sliding element from becoming damaged when opened or closed, since strong forces can be required therefor, because deposits can form between the guide surfaces and the at least one lingual extension.

The guide for the at least one lingual extension of the sliding element can be a slot in the socket of the bracket, which extends in the gingival-occlusal direction transversely through the socket of the bracket from one side to the opposite side. In terms of shaping, a slot of this type is easy to realize. The slot can be disposed at a relative long distance from the base of the channel. The slot could also extend to the base of the channel, and therefore the sliding element, with its at least one lingual extension, would form a part of the base of the channel. However, the base of the channel as a whole is preferably a component of the stationary part of the bracket body and is not also part of the sliding element. This is advantageous for the mechanical loadability of the guidance of the sliding element, favors a sufficiently long guidance of the sliding element, and inhibits deposits of plaque and the like in the region between the at least one lingual extension of the sliding element and its guidance.

In the surface regions of the bracket, which are crucial to the mobility of the sliding element, the adhesion of plaque can be counteracted by a repellent coating or impregnation of a repellent substance e.g. xylan.

The closed position and the open position are preferably defined in that, in both the closed position and in the open position, the sliding element impacts a stop provided on a stationary part of the bracket body. Expediently, the sliding element is held in the closed position, and preferably likewise in the open position, by snapping into the respective position. This can be accomplished in different ways.

According to one embodiment, a recess which extends in the mesial-distal direction and faces the underside of a lingual base of the sliding element is disposed in the base of the bracket body, the recess accommodating a resilient body or resilient cylinder that extends beyond the edge of the recess and acts on the underside of the base. Aforementioned cylinder can be a strand of plastic that is colorless or tooth-colored and that presses against the underside of the base, thereby inhibiting the sliding element. Projections that are disposed on the underside of the base and are directed toward the base of the bracket body can be used to secure the closed position and the open position in a manner such that the sliding element can be moved out of the closed position or out of the open position by moving one of these projections past the resilient cylinder. In one embodiment, the sliding element can be moved out of the closed position or out of the open position only by moving one of those projections past the resilient cylinder. The securement is due to the resilience of the cylinder, until the resistance to the cylinder is overcome.

The projections provided on the underside of the base of the sliding element preferably lie in a flat recess in the underside of the base. This recess, into which the cylinder extends, is expediently closed at both of its ends, thereby forming end stops for the motion of the sliding element.

Conversely, a recess that is open toward the base of the bracket body can be provided in the underside of the sliding element, the recess accommodating a resilient body or cylinder that extends past the edge of the recess and acts on the lingual side of the slot, which, in this case, is provided with projections that preferably lie in a flat recess of the lingual side of the slot and must be overcome by deformation of the cylinder, which yields e.g. in an elastomeric manner, when the sliding element is displaced.

According to another possibility, a projection is provided on the tip of the base, which, in the closed position of the sliding element, snaps into position with the bracket body, preferably on its outer side. In this case, the base has sufficient play in the slot into which it is inserted such that it can spring out of its detent position via its projection. This possibility of spring action can take place in the lingual-labial direction, and in the mesial-distal direction. In the latter case, it is preferable to design the base in the shape of a fork so that it has two arms on which projections are provided that point in opposite directions, thereby securing the sliding element in duplicate in the closed position thereof, and so that the two projections must be deflected out of the detent position thereof to release the sliding element from the closed position thereof thus enabling it to be displaced into its open position.

Two projections, which apply spring action in the distal-mesial direction, can be combined, to advantage, with a third projection disposed therebetween, the third projection being provided on a third lingual arm and being deflectable with spring action in the labial-lingual direction. In this case, this third projection can be used to secure the sliding element in the closed position thereof, and the other two projections can be used to secure the sliding element in the open position thereof—or vice versa.

### BRIEF DESCRIPTION OF THE SEVERAL VIEWS OF THE DRAWINGS

Embodiments of the invention are presented in the attached drawings and are described below. Parts that are identical or similar are labelled in the various examples using the same reference numerals.

FIG. 1 shows a first bracket, according to the invention, as viewed in the longitudinal direction of the slot,

FIG. 2 shows the bracket depicted in FIG. 1, in a side view,

FIG. 3 shows the bracket depicted in FIG. 2, in section A-A according to FIG. 2,

FIG. 4 shows the bracket depicted in FIG. 2, in section B-B according to FIG. 2,

FIG. 5-7 show different oblique views of the bracket depicted in FIGS. 1 through 4,

FIG. 8 shows the bracket depicted in FIGS. 1 through 7 in a view as depicted in FIG. 1, but in the open position thereof,

FIG. 9 shows the bracket depicted in FIG. 8, in a sectional view as depicted in FIG. 3, but in the open position thereof,

FIG. 10 shows the bracket depicted in FIG. 8, in a sectional view as depicted in FIG. 4, but in the open position thereof,

FIG. 11-13 show oblique views of the bracket depicted in FIGS. 1 through 10, in the open position thereof,

FIG. 14 shows a second embodiment of a bracket in a view corresponding to that of FIG. 1,

FIG. 15 shows the bracket depicted in FIG. 14, in a side view,

FIG. 16 shows the bracket depicted in FIG. 15, in section B-B according to FIG. 14,

FIG. 17 shows the bracket depicted in FIGS. 15 and 16, in section A-A according to FIG. 15,

FIGS. 18 and 19 show different oblique views of the bracket depicted in FIGS. 14 through 17,

FIG. 20 shows a third embodiment of the bracket in a view corresponding to that of FIG. 1,

FIG. 21 shows the bracket depicted in FIG. 20, in a side view,

FIG. 22 shows the section A-A according to FIG. 21,

FIG. 23 shows the detail D depicted in FIG. 22,

FIGS. 24 and 25 show oblique views of the bracket depicted in FIGS. 20 through 23,

FIG. 26 shows the bracket depicted in FIGS. 20 through 25 in a view as depicted in FIG. 20, but in the open position thereof,

FIG. 27 shows the bracket depicted in FIG. 26, in a side view according to FIG. 21,

FIG. 28 shows the bracket depicted in FIG. 26, in a side view according to FIG. 22,

FIG. 29 shows detail D depicted in FIG. 28,

FIGS. 30 and 31 show the bracket depicted in FIGS. 26 through 29, in two different oblique views,

FIG. 32 shows a fourth embodiment of the invention in a view corresponding to that of FIG. 1,

FIG. 33 shows the bracket depicted in FIG. 32, in a side view,

FIG. 34 shows the bracket depicted in FIGS. 32 and 33, in section A-A according to FIG. 37,

FIG. 35 shows detail D depicted in FIG. 34, and

FIGS. 36 and 37 show different oblique views of the bracket depicted in FIGS. 32 through 35.

### DETAILED DESCRIPTION OF THE INVENTION

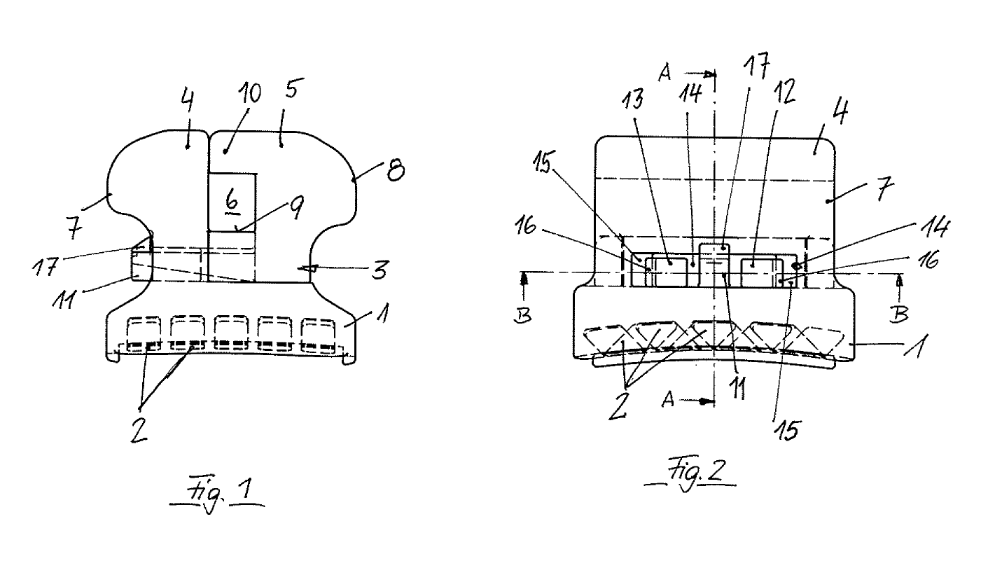

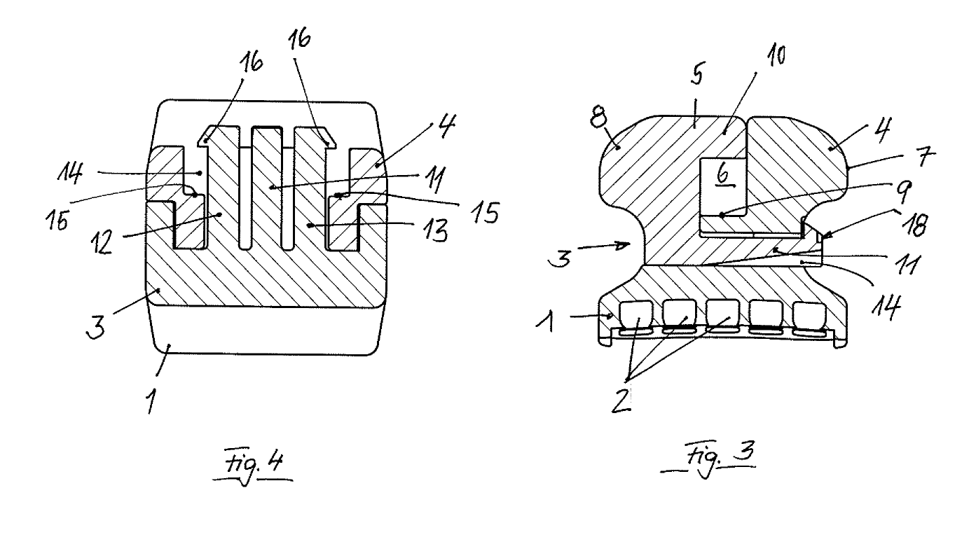

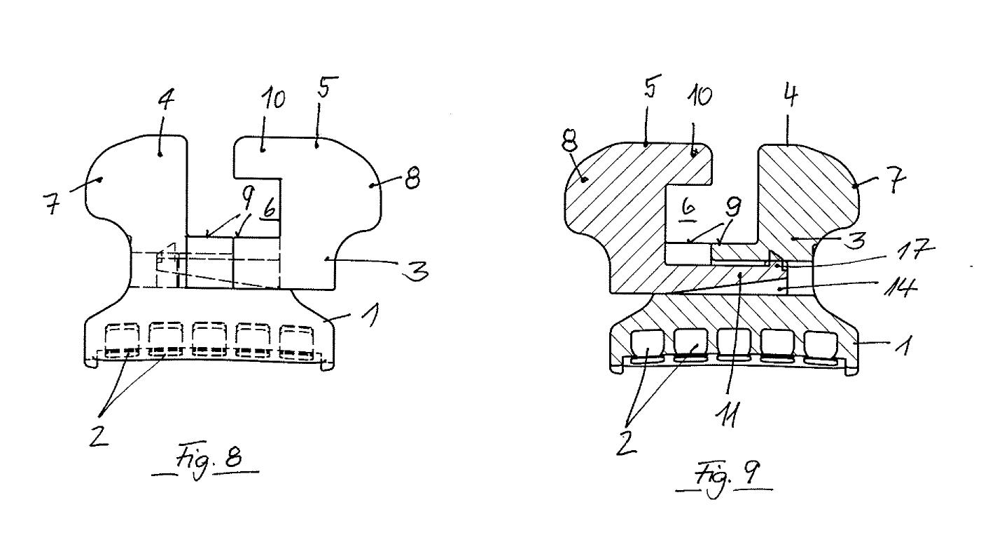

The self-ligating bracket depicted in FIGS. 1 through 12 has a curved base 1, the curvature of which traces the front side of a tooth. On the underside of base 1, which forms the lingual side of the bracket, base 1 includes recesses 2 which are arranged in a row and have an undercut design. Recesses 2 have a rectangular contour in the cross-sectional view which is shown in FIG. 3. In a cross-sectional view perpendicular thereto, recesses 2 have a diamond-shaped contour, as shown in FIG. 2. An adhesive can be applied to the underside of the bracket to bond the bracket to a tooth. The adhesive interlocks undercut recesses 2 and ensures good adhesion. In each individual row, recesses 2 and, together therewith, the undercuts, are oriented in the same direction. From row to row, however, they alternate between an orientation in one direction and an orientation in the other direction. A push in the mesial-to-distal direction that acts on the bracket therefore results in the same adhesion as does a push in the distal-to-mesial direction. When a push occurs in the occlusal-gingival direction or in the gingival-occlusal direction, adhesion is high regardless of the pushing direction.

Base 1 comprises a gingival wall 4 and an occlusal wall 5. Walls 4 and 5 extend parallel to each other and enclose between them a channel 6 which, in the closed state of the bracket, has a rectangular inner cross-section and extends continuously in a straight line from distal to mesial through the bracket.

A ligature wing 7 that extends in the gingival direction is provided on gingival wall 4. A ligature wing 8 that extends in the occlusal direction is provided on occlusal wall 5. Ligature wires can be applied thereto in a manner known to a person skilled in the art. In the embodiment shown, ligature wings 7 and 8 are not divided; as an alternative, each one can be subdivided into a pair of gingival and occlusal ligature wings.

Channel 6 is used to receive an orthodontic archwire which has a rectangular cross-section in particular, but which can also have a circular cross-section, and is not a component of the bracket. By tightening the archwire, pressure can be exerted on base 9 of channel 6 and on walls 4 and 5 of the bracket. When the archwire has a rectangular cross-section, it can also be used to apply torque to walls 4 and 5 of the bracket. For this purpose, the inner cross-section of channel 6 is substantially rectangular in design. It is limited by base 9 of channel 6, gingival wall 4, occlusal wall 5, and labial extension 10 of occlusal wall 5, which, in the closed state of the bracket depicted in FIG. 1, extends to gingival wall 4 and limits channel 6 in the labial direction.

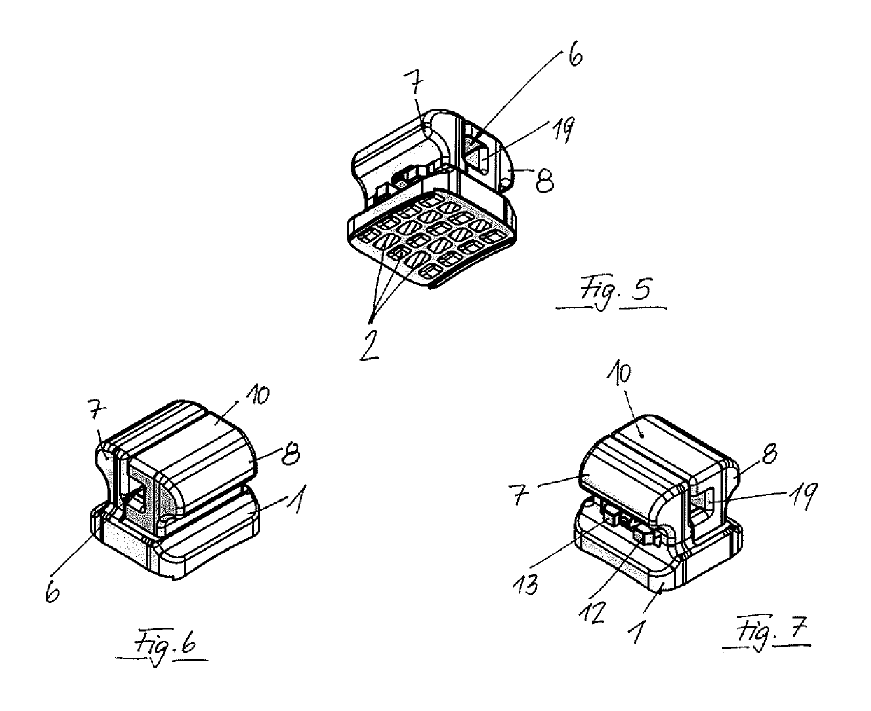

Edges 19 of channel 6 are rounded at the ends of channel 6, as shown in FIGS. 5 through 7, thereby reducing friction for the archwire situated in channel 6 and providing an advantage in cases, in particular, of a significant misalignment of teeth, which demands that the archwire assume a particularly irregular course along the mandibular arch.

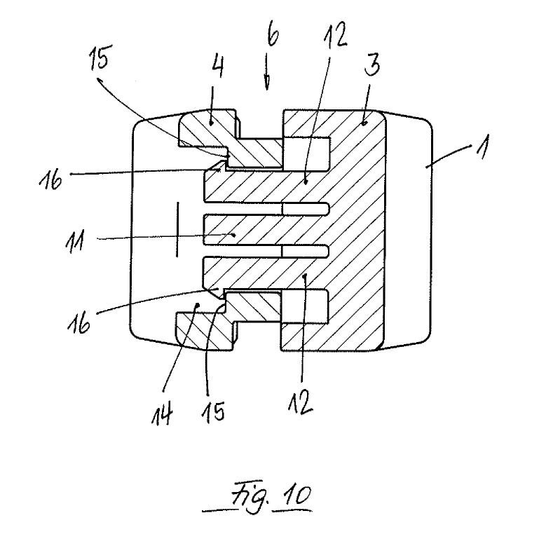

While gingival wall 4, including ligature wing 7, is connected to base 1 as a single piece, the occlusal wall, including ligature wing 8, is situated on base 1 in a displaceable manner. Occlusal wall 5 can be displaced, in the gingival-to-occlusal direction, from the position depicted in FIG. 1, in which labial extension 10 closes channel 6 on the labial side, into the open position depicted in FIGS. 8 and 9, in which occlusal wall 5 has increased its distance away from gingival wall 4, and there is distance in particular between labial extension 10 of occlusal wall 5 and diametrically opposed gingival wall 4, the distance being at least as great and preferably as great as the width of channel 6, as measured in the gingival-occlusal direction, in the closed state, as shown in FIG. 1. This makes it possible to insert an archwire into the channel, transversely to its longitudinal extension, the archwire having a thickness in the gingival-occlusal direction that, at most, is as great as the width of channel 6, as measured in the gingival-occlusal direction, in the closed state of the bracket, all of this taking place when the displaceable wall of the bracket, which is preferably occlusal wall 5, is in the open position thereof, as shown in FIGS. 8 and 9. Once displaceable wall 5 has been moved from the open position thereof (FIGS. 8 and 9) into the closed position thereof (FIGS. 1 and 3), an archwire that has been inserted into channel 6 is held captive in channel 6.

To enable occlusal wall 5 of the bracket to be displaced, occlusal wall 5 includes, as lingual extensions on the lingual end thereof, three adjacently disposed arms 11, 12, and 13 which preferably extend parallel to each other, extend at a right angle to the longitudinal extension of channel 6, and extend into a guide formed as a slot 15 provided underneath base 9 of channel 6 in the center of gingival wall 4. Together with arms 11, 12, and 13, occlusal wall 5 forms a sliding element 3 of the bracket. The cross section of slot 14 is selected such that it causes the sliding element to be guided in a straight line when the sliding element is displaced back and forth between the open position thereof and the closed position thereof. In the gingival direction, slot 14 expands in a stepped manner in the mesial-distal direction, thereby forming two stops 15 for projections 16 on the exposed ends of outer arms 12 and 13. Projections 16 point in opposite directions and extend in the mesial direction and the distal direction. The impact of projections 16 against stops 15 limits the opening motion of sliding element 3 and ensures that sliding element 3 cannot get lost when the bracket is opened.

Middle arm 11 includes a projection 17, which projects outwardly in the lingual direction, bears against the gingival outer side of gingival wall 4 when the bracket is in the closed position (FIG. 1), and prevents the bracket from opening accidentally. To open, the end of middle arm 11, which extends beyond the gingival outer side of gingival wall 4, is pressed in the lingual direction i.e. toward base 1, and is slid in the occlusal direction, thereby resulting in projection 17 dropping into slot 14, in which it does not block occlusal wall 5 from being displaced in the occlusal direction. Middle arm 11 includes a recess 18 in its exposed end, which makes it easy to depress middle arm 11 by making it easy to act on arm 11 using a tool, e.g. a scaler, and press arm 11 against base 1. Since middle arm 11 is pressed toward base 1 to release sliding element 3, a bending stress is generated in middle arm 11, which is retained for as long as the bracket is open, either entirely or partially. When sliding element 3 is slid back into the closed position thereof (FIG. 1), middle arm 11 springs back under the action of the released bending stress, and therefore projection 17 snaps into position on the gingival outer side of gingival wall 4.

When sliding element 3 is displaced between a closed position thereof and an open position thereof, the two outer arms 12 and 13 do not undergo bending stress; they are acted upon by bending stress only one time, which is when they are first inserted into slot 14 to connect the two initially separated components of the bracket. To facilitate the insertion of arms 11, 12 and 13 into slot 14, projections 16 and 17 are bevelled, as shown in FIGS. 1 and 10.

FIGS. 1, 2, and 3 show how projection 17 of middle arm 11 is snapped into position with the outer side of gingival wall 4 when the bracket is in the closed position. FIG. 10 shows how projections 16 of outer arms 12 and 13 bear against stops 15 when the bracket is in the open position.

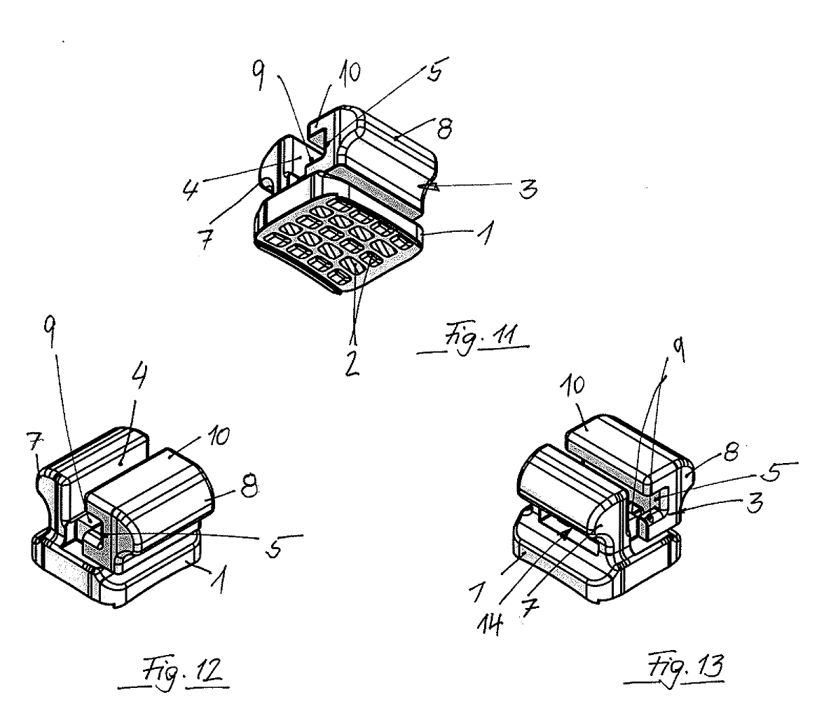

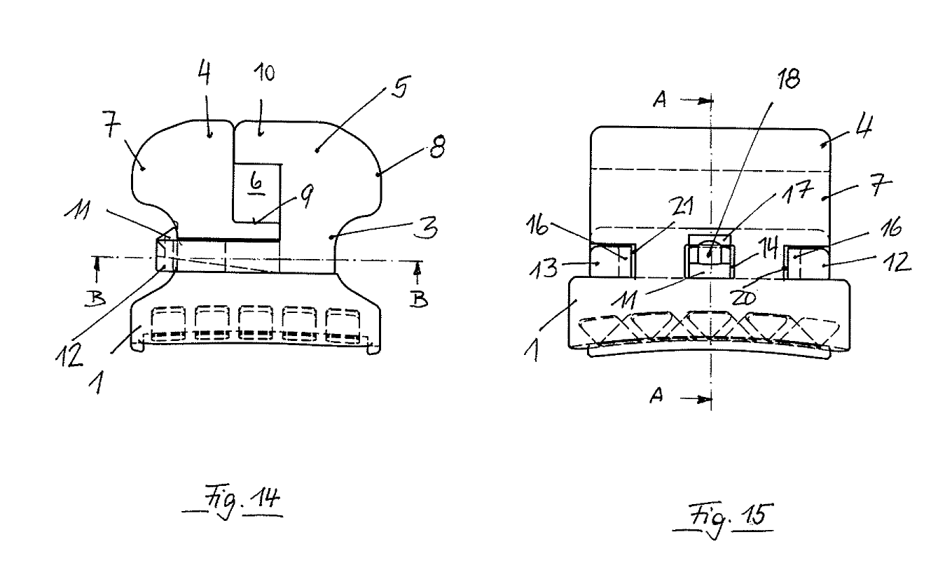

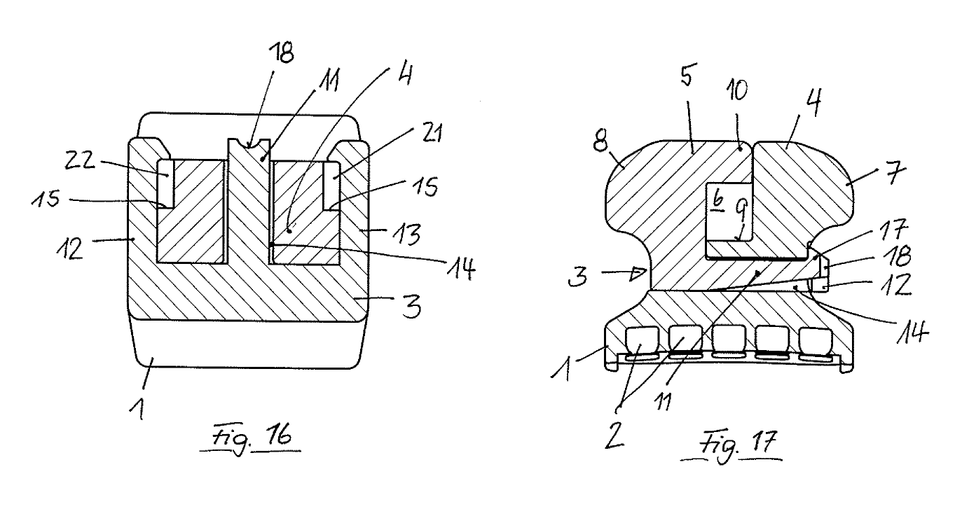

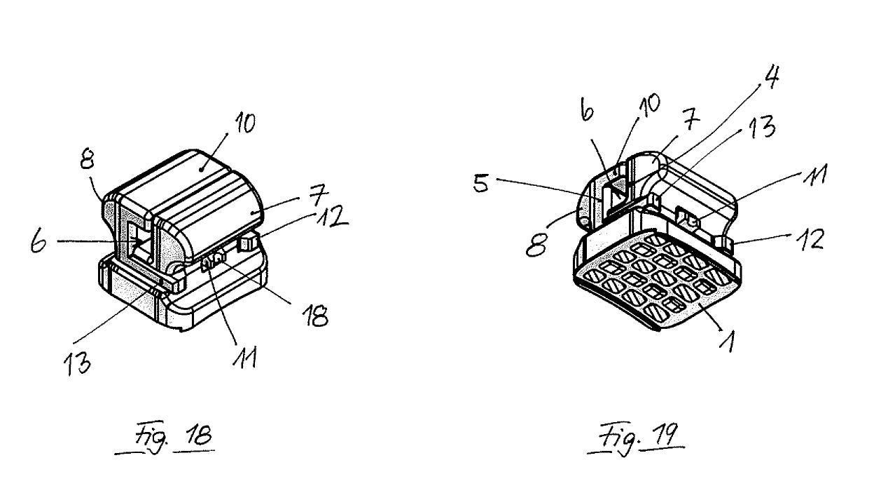

FIGS. 5 through 7 show the bracket in the closed state thereof, and FIGS. 11, 12, and 13 show the bracket in the open position thereof. Base 9 of channel 6 is formed partially in occlusal wall 5 and partially in gingival wall 4. The sections of base 9 formed in the occlusal wall and in the gingival wall extend along the entire width of channel 6 when the bracket is closed. This provides the advantage that an archwire that is inserted into channel 6 when the bracket is open always impacts base 9 of channel 6, but does not enter base 9 and thereby prevent the bracket from closing.

The bracket, which is shown in FIGS. 1 through 12, can be composed of metal, plastic, or ceramic. The design that is shown is suited, in particular, to be manufactured using a metal injection molding process (MIM, Metal Injection Molding), a plastic injection molding process, or a ceramic injection molding process (CIM, Ceramik Injection Molding), thereby ensuring production that is efficient and repeatedly precise, which is of particular significance for small components of this type such as orthodontic brackets.

Although ceramics usually do not have good elastic properties, the minor elastic deflections that are desired for arms 11, 12, and 13 can also be attained using ceramic materials, in particular aluminum oxide or zirconium oxide which are particularly suitable for ceramic brackets according to the invention.

The second embodiment of the invention differs from the first embodiment in that the two outer lingual arms 12 and 13 of sliding element 3 are not disposed together with middle lingual arm 11 in the same centrally located slot 14 of gingival wall 4. In the second embodiment, only middle arm 11 is inserted in middle slot 14. The two outer arms are inserted into grooves 20 and 21, which are situated on the outer side and are parallel to middle slot 14, in the lower region of gingival wall 4, grooves 20 and 21 preferably being situated the same distance away from the plane of base 9 of channel 6 as is middle slot 14. In contrast to the first embodiment, the two outer arms 12 and 13 do not have projections that face away from each other, but rather projections 16 that face each other. When the bracket is in the open position, projections 16 impact shoulders 22 which are formed in grooves 20 and 21 and point in the gingival direction.

Middle arm 11 includes, on its end, a recess 18 which is formed as a channel, is closed toward base 1, and makes it easy to use a tool to easily enable middle arm 11 to release sliding element 3.

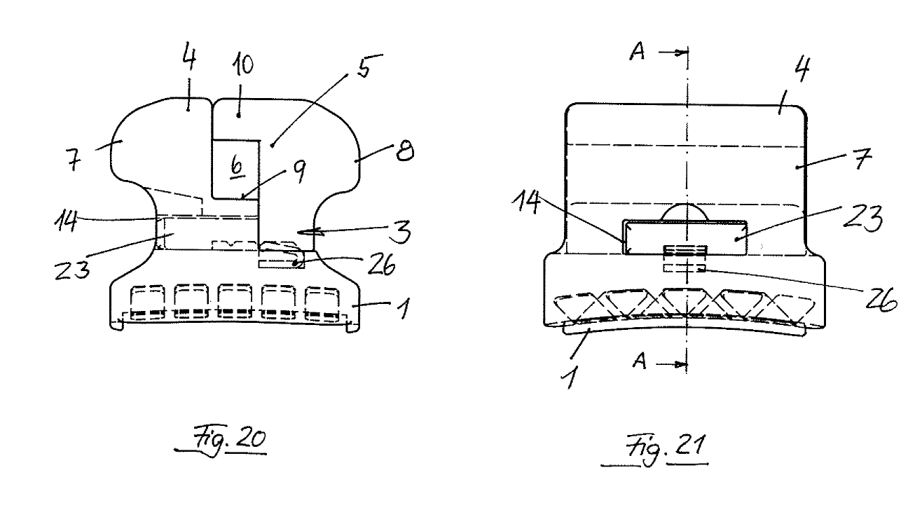

Two oblique views of the bracket according to the second embodiment are depicted in FIGS. 18 and 19.

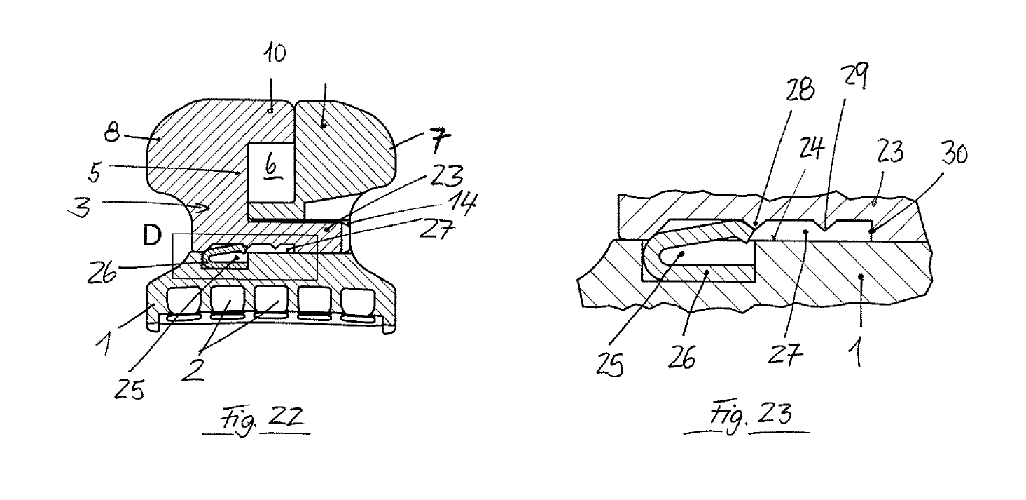

The third embodiment of the invention, which is depicted in FIGS. 20 through 25, differs from the first embodiment in that sliding element 3 does not include three parallel arms on its lower end, but rather one wider lingual base 23 which can be displaced in a centrally located slot 14 which extends through gingival wall 4 of the bracket in the gingival-occlusal direction underneath base 9 of channel 6. A recess 25 is provided in lingual surface 24 of slot 14, which is otherwise flat. A leaf spring 26 folded in the shape of a “V” is provided in recess 25 and extends via one leg out of recess 25 and into slot 14. Leaf spring 26 acts on the underside of sliding element 3 which, to this end, includes a flat recess 27 facing base 1, in which two ribs 28 and 29 extending parallel to channel 6 are provided, ribs 28 and 29 tapering in the shape of a wedge in the direction toward base 1. In the closed position of the bracket, which is depicted in FIG. 20, one rib 28 bears against the leg of leaf spring 26 that extends into recess 27. To open the bracket, a tool can be used to press on the gingival end of lingual base 23. Rib 28 then moves past leaf spring 26 which is compressed. The displacement motion ends at the latest when leaf spring 26 impacts end 30 of recess 27. This marks the open position of the bracket. On the way to the open position, leaf spring 26 preferably also overcomes second rib 29, thereby ensuring that the bracket is also held open provided that sliding element 3 thereof is not intentionally moved into the closed position.

To make it easier for ribs 28 and 29 to overcome leaf spring 26, the leg of leaf spring 26 is folded over into recess 27, and therefore ribs 28 and 29 impact a slanted surface of leaf spring 26 which is more easily overcome by ribs 28 and 29 via their own slanted surface.

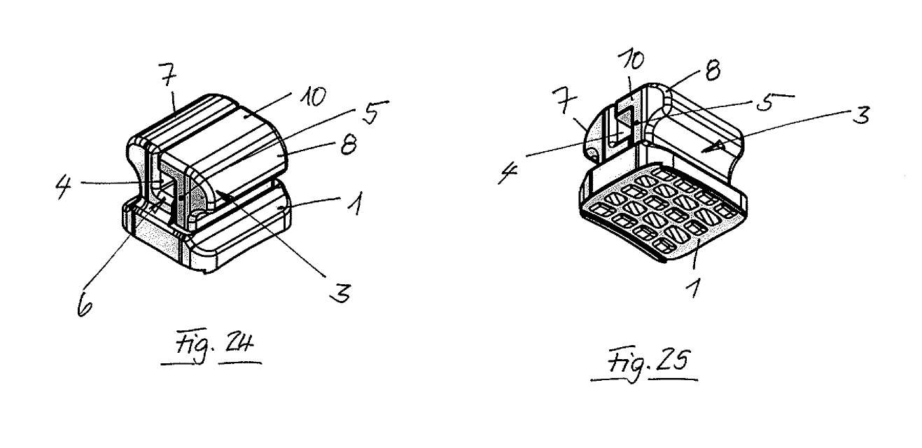

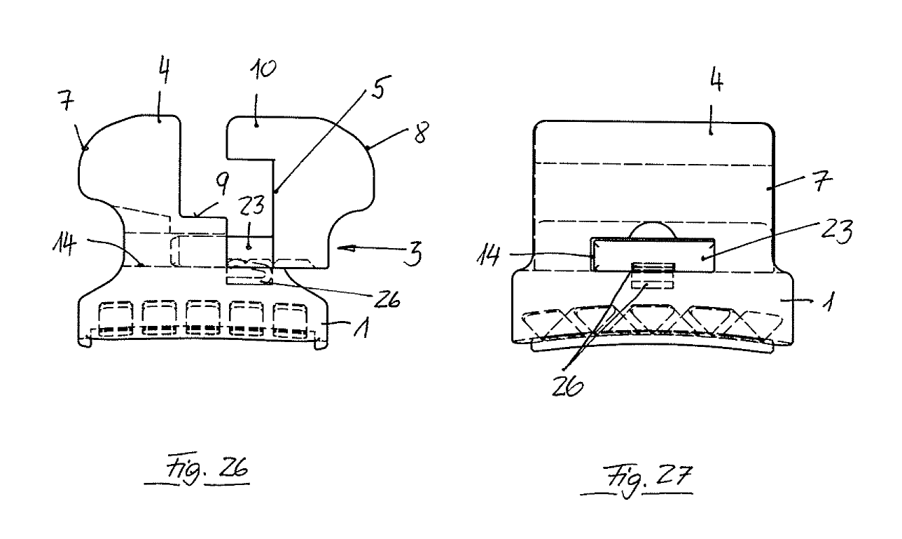

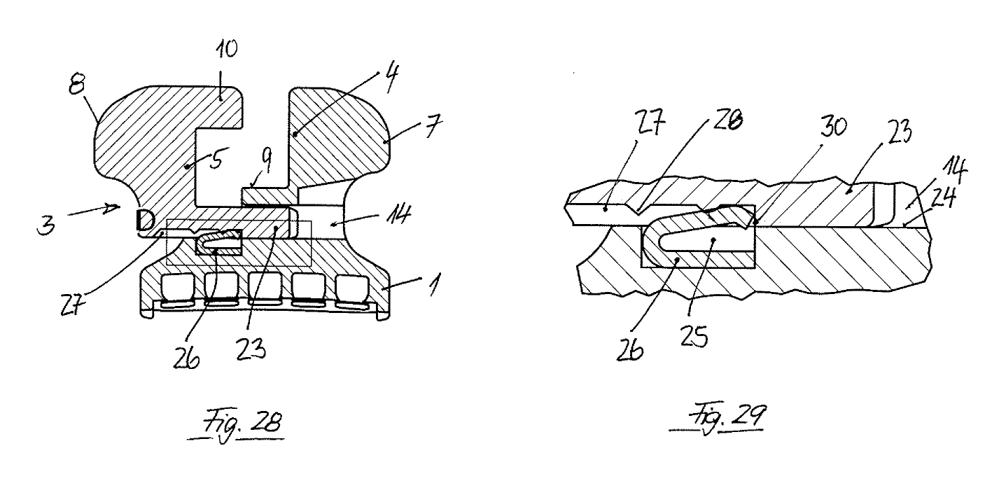

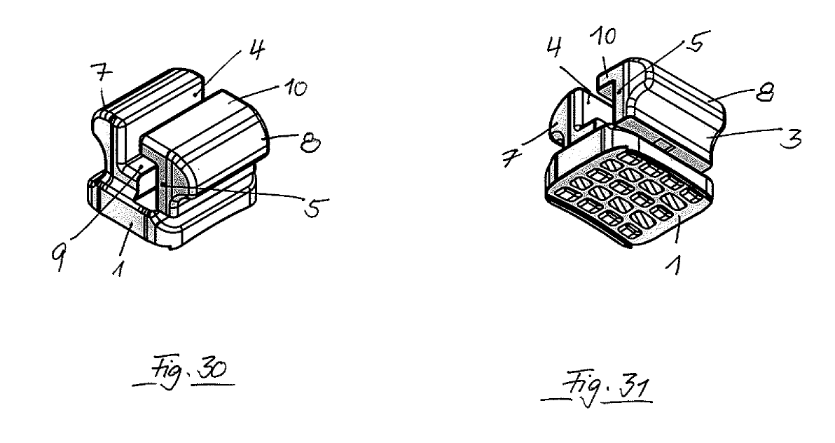

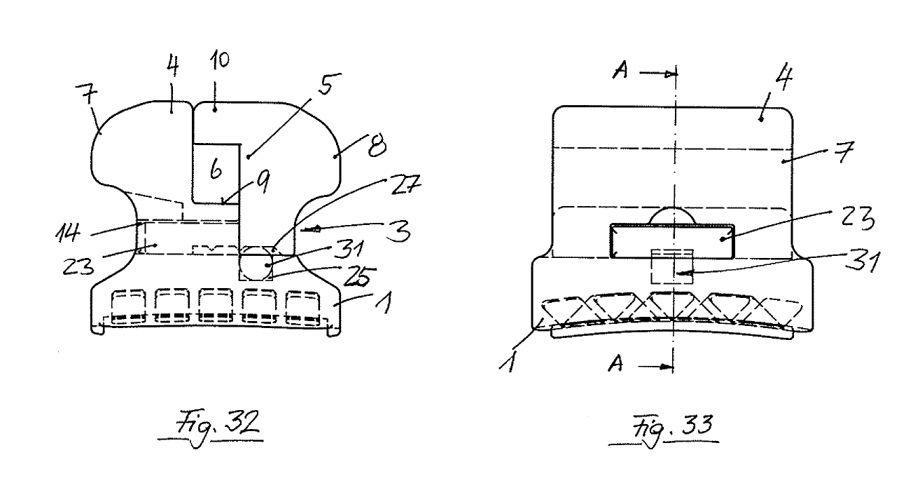

The third embodiment is particularly advantageous and aesthetic, because the mechanisms used to hold the bracket open and closed are hidden in the bracket. FIGS. 24 and 25 show the closed bracket in two different oblique views. FIGS. 30 and 31 show the open bracket in two different oblique views.

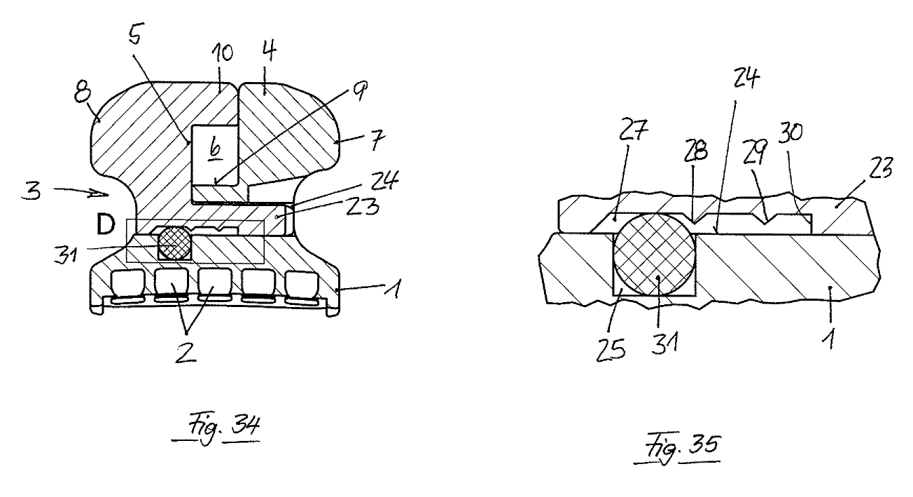

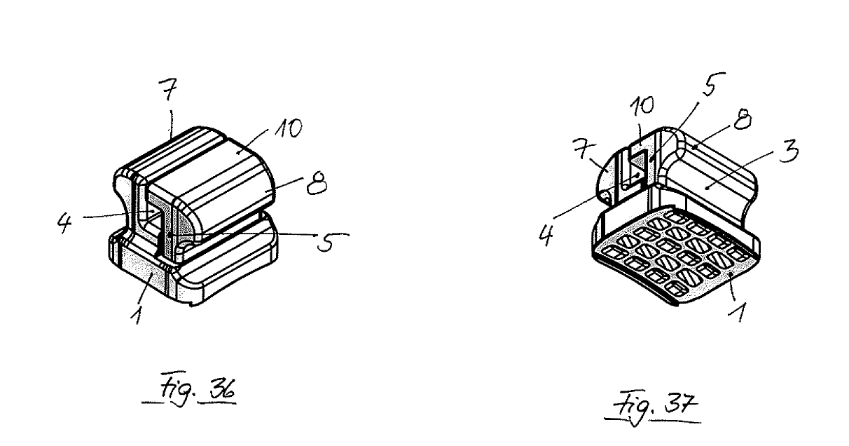

The fourth embodiment of a bracket, which is depicted in FIGS. 32 through 37, differs from the third embodiment in that a leaf spring folded in the shape of a “V” is not provided in recess 25 in base 1, but rather an elastomeric cylinder 31 is, which performs the same function as spring 26 in the third embodiment.

In the second, third, and fourth embodiments as well, the components of the bracket—except for leaf spring 26 and the elastomeric cylinder—can be composed either of metal, in particular stainless steel, a plastic e.g. polyoxymethylene (POM), or a ceramic e.g. aluminium oxide or zirconium oxide.

### LIST OF REFERENCE NUMERALS

1. Base
2. Recess
3. Sliding element
4. Gingival wall
5. Occlusal wall
6. Channel
7. Ligature wing
8. Ligature wing
9. Base of channel 6
10. Labial extension of the occlusal wall
11. Arm, lingual extension of the occlusal wall
12. Arm, lingual extension of the occlusal wall
13. Arm, lingual extension of the occlusal wall
14. Slot, guide
15. Stops
16. Projection
17. Projection
18. Recess
19. Edges of channel 6
20. Groove, guide
21. Groove, guide
22. Shoulders
23. Base
24. Surface
25. Recess
26. Leaf spring
27. Recess
28. Rib
29. Rib
30. End of the recess
31. Elastomeric cylinder/resilient body

1. A self-ligating bracket for orthodontics comprising
a bracket body having a base,
an occlusal wall extending away from the base and having at least one occlusal ligature wing,
a gingival wall extending away from the base and having at least one gingival ligature wing,
a channel which extends between the occlusal wall and the gingival wall continuously in the direction from mesial to distal,
a sliding element, which is held in a guide of the bracket and can be displaced in the guide, back and forth in the gingival-occlusal direction, between a closed position, in which the channel is closed along at least a portion of its length, and an open position, in which the channel is open in the labial direction,
and structure that can hold the sliding element in the closed position thereof and captively secure the sliding element in the open position thereof, the structure being integrated in the bracket,
wherein
the at least one gingival or occlusal ligature wing and the associated gingival or occlusal wall of the channel are components of the sliding element;
the sliding element has one or more lingual extensions which extend parallel to the base of the channel;
the at least one lingual extension is guided in the guide;
the guide includes a slot which extends underneath the channel in the bracket, parallel to the base of the channel;
at least the gingival wall or the occlusal wall of the channel has, at a distance from the base of the channel, a labial extension that extends in the direction toward the opposite wall of the channel.

2. The bracket according to claim 1, wherein the guide extends continuously from the gingival side to the occlusal side of the bracket.

3. The bracket according to claim 1, wherein a recess extending in the mesial-distal direction is disposed in the side of the bracket base facing the underside of the at least one lingual extension, recess accommodating a resilient body that extends beyond the edge of the recess and acts on the underside of the at least one lingual extension.

4. The bracket according to claim 3, wherein the recess is closed at both ends.

5. The bracket according to claim 3, wherein a further recess is provided in the underside of the at least one lingual extension, and in that the resilient body extends into this further recess.

6. The bracket according to claim 5, wherein at least one projection is a rib extending in the distal-mesial direction and is provided in the recess of the at least one lingual extension.

7. The bracket according to claim 6, wherein the projection overcomes the resilient body when the sliding element is moved from the closed position thereof into the open position thereof, accompanied only by a reversible deformation of the resilient body.

8. The bracket according to claim 3, wherein the resilient body is a cylinder or a curved leaf spring, in particular a V-shaped leaf spring.

9. The bracket according to claim 1, wherein at least one projection is provided on the tip of the at least one lingual extension, the projection snapping into position with a non-displaceable part of the bracket in the closed position of the sliding element, and in that the at least one lingual extension has sufficient play in the slot such that the at least one projection can be moved out of its detent position in a resilient manner.

10. The bracket according to claim 1, wherein it is coated or impregnated, at least in regions, with a substance that counteracts the adhesion of plaque.

11. The bracket according to claim 1, wherein the base of the channel is connected partially to the gingival wall and partially to the occlusal wall, and in that, in the closed state of the bracket, the sections of the base of the channel mounted on the occlusal wall extend at least to the gingival wall, and in that the sections of the base of the channel mounted on the gingival wall extend at least to the occlusal wall.
